(19) United States
(12) Patent Application Publication
(10) Pub. No.: US 2017/0039874 A1
(43) Pub. Date: Feb. 9, 2017

(54) ASSISTING A USER IN TERM IDENTIFICATION

(71) Applicant: Lenovo (Singapore) Pte. Ltd., Singapore (SG)

(72) Inventors: Nathan J. Peterson, Durham, NC (US); Russell Speight VanBlon, Raleigh, NC (US); Arnold S. Weksler, Raleigh, NC (US); Rod D. Waltermann, Rougemont, NC (US); John Carl Mese, Cary, NC (US)

(21) Appl. No.: 14/816,793

(22) Filed: Aug. 3, 2015

(51) Int. Cl. G09B 19/00; G09B 5/00

(52) U.S. Cl. CPC G09B 19/00; G09B 5/00

(57) ABSTRACT

One embodiment provides a method including: obtaining, using a processor, content from a source, wherein the content comprises a plurality of terms; determining, using a processor, that at least one of the plurality of terms is unfamiliar to a user; and providing, to the user, assistance relating to identification of the at least one of the plurality of terms determined to be unfamiliar. Other aspects are described and claimed.

### BACKGROUND

People are continually exposed to content in different settings, for example, reading content on a computer screen, listening to a conversation, watching television, and the like. Frequently, a person may be exposed to a term (e.g., words, phrases, expressions, chemical formulas, etc.) contained within the content, that they are unfamiliar with, for example, the person has never seen or heard the term before or does not remember what the term means. Depending on the type of content, the person unfamiliar with the term may look up the term, ask for clarification, attempt to understand the gist of the term based upon context, or ignore the term completely. For example, the person may look up the term, for example, on an information handling device (e.g., smart phone, tablet, computer, etc.) if available. However, certain content situations may not allow the person the ability to look up the term, for example, during a conversation.

### BRIEF SUMMARY

In summary, one aspect provides a method, comprising: obtaining, using a processor, content from a source, wherein the content comprises a plurality of terms; determining, using a processor, that at least one of the plurality of terms is unfamiliar to a user; and providing, to the user, assistance relating to identification of the at least one of the plurality of terms determined to be unfamiliar.

Another aspect provides an information handling device, comprising: a processor; a memory device that stores instructions executable by the processor to: obtain content from a source, wherein the content comprises a plurality of terms; determine that at least one of the plurality of terms is unfamiliar to a user; and provide, to the user, assistance relating to identification of the at least one of the plurality of terms determined to be unfamiliar.

A further aspect provides a product, comprising: a storage device that stores code executable by a processor, the code comprising: code that obtains content from a source, wherein the content comprises a plurality of terms; code that determines that at least one of the plurality of terms is unfamiliar to the user; and code that provides, to the user, assistance relating to identification of the at least one of the plurality of terms determined to be unfamiliar.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of assisting a user in term identification.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Even though there are greater than 170,000 words in the English language, the average high school/college graduate knows between 10,000-20,000 words of the English language. The average medical school graduate knows approximately 30,000 words. Additionally, people in different occupations or fields may use terms that are familiar to that occupation or field but are unfamiliar to those outside those occupations or fields. For example, when conversing with people in other professions like doctors, engineers, lawyers, etc., terms that are well known in that field are often used indiscriminately even when they are conversing with someone unfamiliar with that field or terms. What we need is a way of quickly understanding new terms as they are presented to us in order to learn new terms quicker.

One current solution, if a person is consuming content alone, for example, while reading, watching TV, or consuming the Internet, is to stop and look up definitions of words or terms they are not familiar with. However, this method is time consuming and frequently leads to the person getting off topic. For example, the person may do an Internet search on the term intending only to get the definition, but instead ends up reading articles regarding the origin and colloquial uses of the term.

If a person is conversing with another person or is a part of a live discussion, it may be difficult to stop and look up a definition. For example, it may be rude to look at an information handling device and conduct a search to help define the term. Additionally, even if this is possible, the person may miss parts of the conversation if they are focused on finding the definition of a term. If the person is engaged in a casual conversation, the person may be able to stop the speaker and ask what that term means. However, this is not always an option. Additionally, the speaker may know what the terms means but may have difficulty articulating the meaning in such a manner that the person can understand.

Due to the increase in technology, most people generally have an information handling device (e.g., computer, tablet, cellular phone, smart watch, television, etc.) readily accessible at the times when they are consuming content, for example, a person may be using a device to consume the content. It would be helpful if we could leverage the prevalence of information handling devices to assist a user in identifying unknown or unfamiliar terms (e.g., phrases, words, expressions, chemical symbols, etc.). For ease of writing the term “unfamiliar term” will be used, however, this should be understood to encompass not only terms that a user may not have ever known but also terms which the user may have been exposed to but may not remember.

These technical issues present problems for users in trying to understand unfamiliar terms. Conventional methods require that the user stop consuming the content to look up the term. Additionally, in some situations, a user may not be able to stop the content, for example, during a conversation, in order to identify a term. As such, a technical problem is found in that conventional techniques for identifying unfamiliar terms fail to leverage information handling devices to assist in identifying unfamiliar terms and providing assistance to a user when an unfamiliar term is encountered within content.

Accordingly, an embodiment provides a method of monitoring content consumed by a particular user and identifying a term contained within the content that may be unfamiliar to a user. An embodiment may then provide assistance to the user identifying the term. An embodiment may obtain content from a source where the content comprises a plurality of terms. Terms may include words, phrases, expressions, slang, chemical notations, formulas, acronyms, and the like. The content may include a conversation, Internet page, television show, and the like.

An embodiment may identify a user consuming the content as a particular user. Based upon the particular user, an embodiment may determine that a term contained within the content is unfamiliar to the user. For example, in one embodiment, the user may train the system to learn the vocabulary of the user, for example, during an initialization period. This initialization may then be used by the system to determine what terms a user is likely unfamiliar with. Alternatively, an embodiment may start from the user having a small vocabulary and offer assistance for every term. In one embodiment, the determination is made based upon a probability of whether the user is unfamiliar with the term. A combination of determination techniques may also be used.

After determining that the user may be unfamiliar with the term, an embodiment may provide assistance to the user relating to identifying the term. In one embodiment, the assistance may include asking or prompting the user if they need assistance in identifying the term. Assistance in identifying the term may include providing a definition of the term or may include providing synonyms. Other types of assistance are possible.

The illustrated example embodiments will be best understood by reference to the figures. The following description is intended only by way of example, and simply illustrates certain example embodiments.

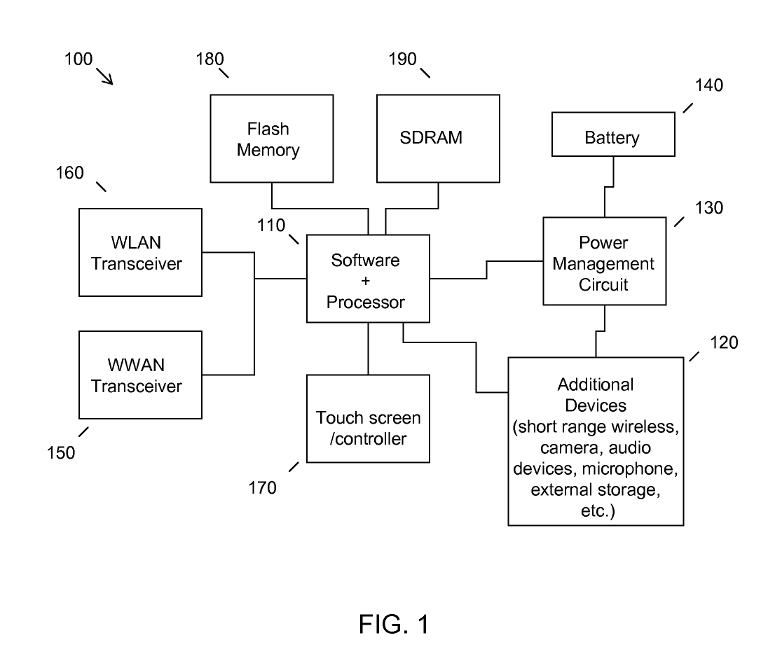

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, a microphone, and the like. System 100 often includes a touch screen 170 for data input and display/rendering. System 100 also typically includes various memory devices, for example flash memory 180 and SDRAM 190.

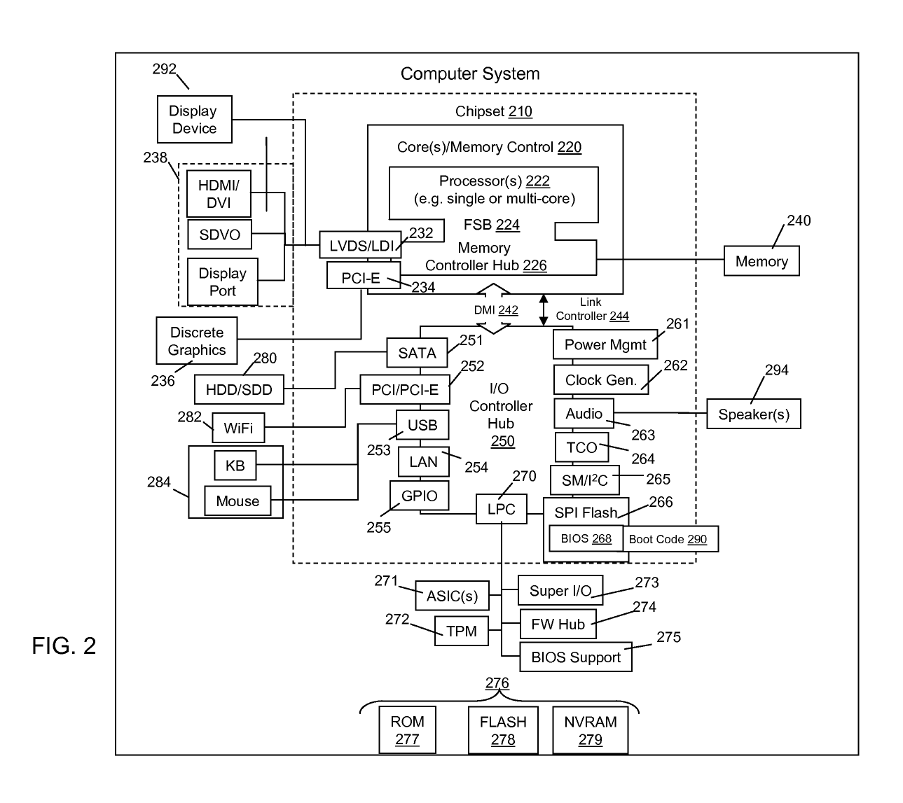

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, smart watches, personal computer devices generally, and/or electronic devices which users may use to identify unfamiliar terms. Additionally, the circuitry outlined in FIG. 1 or FIG. 2 may be used to monitor content and provide assistance in identifying unfamiliar terms. For example, the circuitry outlined in FIG. 1 may be implemented in a tablet or smart phone embodiment, whereas the circuitry outlined in FIG. 2 may be implemented in a personal computer embodiment.

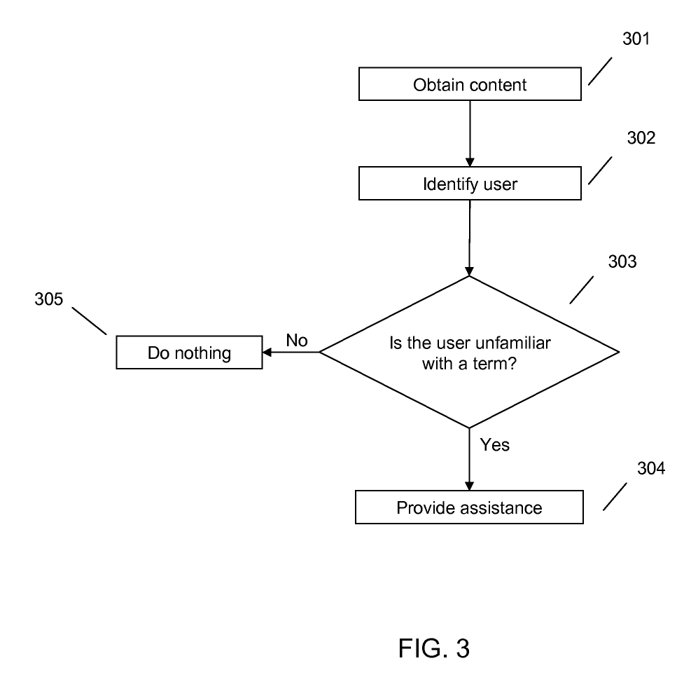

Referring now to FIG. 3, at 301, an embodiment may obtain content comprising a plurality of terms from a source. Obtaining may be accomplished through a variety of methods, for example, receiving content, importing content, capturing content, and the like. As an example, obtaining may include receiving the content from a secondary source. For example, a television may be connected either via a wire or wirelessly to another information handling device and the television may be feeding the content to the information handling device. Obtaining may also include capturing the content. For example, a person may be having a conversation with another person and an information handling device may use a microphone to capture the content of the conversation. Other methods of obtaining content are contemplated.

The content may include, for example, a conversation, Internet webpage, television show, a book, or any other type of content containing terms. The source may be a microphone for audio capture, a camera for video or gaze tracking capture, an information handling device containing or sourcing the content, and the like. To obtain content, an embodiment may continually monitor audio received or may identify what a user is looking at based upon gaze tracking data. For example, if a user is watching a television show, an embodiment may capture or receive subtitles if they are included, capture audio, or may identify the television show and may gather the content from a database or other source containing the dialogue, a transcript, or other source of data.

One embodiment may, at 302, identify the user consuming the content. The identification may include identifying the particular person, for example, the user is Jane. Alternatively or additionally, the identification may include just identifying a profile belonging to a person, for example, a person has logged into an information handling device under a particular profile. In one embodiment, this identification may be accomplished using user credentials. For example, when a user logs into an information handling device, an embodiment may use these credentials to identify the user using the device. Another method for identification includes using biometric identification, for example, using voice recognition, fingerprint identification, facial recognition, and the like. Other mechanisms for user identification are contemplated and possible.

An embodiment, at 303, may determine that at least one of the terms in the content is unfamiliar to the user. The determination may not definitively know that the user is unfamiliar with the term. In other words, an embodiment may determine that a term is unfamiliar to the user even though the term is actually familiar to the user. Conversely, an embodiment may determine that the user is familiar with a term even though the user is unfamiliar with the term. For example, in one embodiment, the determination may be made based upon a calculation of a probability relating to the likelihood that the user is unfamiliar with the term. This probability may be related to other terms that the user is familiar or unfamiliar with. For example, an embodiment may calculate a probability that the user is unfamiliar with a term based upon whether the user is unfamiliar with similar terms.

In one embodiment, the determination may be made using a look-ahead strategy or may occur in a more real-time monitoring. As an example, if a user is reading a book on a device, an embodiment may scan the entire page and note the terms which it has determined are unfamiliar to the user. Alternatively, an embodiment may monitor the gaze of the user and only indicate a term as unfamiliar when the user's gaze is close to that term (i.e., they are about to read the term). The look-ahead versus real-time strategy may be somewhat dependent on the source, for example, an embodiment may not be able to provide a look-ahead for a real-time conversation. Additionally, the look-ahead versus real-time strategy may be chosen by the user. For example, the user may choose to have an embodiment do a look-ahead if possible.

As a basis for making the determination at 303, an embodiment may know a base vocabulary associated with a user. For example, once the user has been identified, an embodiment may correlate that particular user with a known vocabulary base. In one embodiment, the vocabulary base may be based upon known features of the user. For example, the user may indicate their level of education, profession, hobbies, age, and other parameters. Alternatively or additionally, an embodiment may use outside sources (e.g., social media, location data, network data, etc.) to determine known features about the user. An embodiment may then use this information to create an estimated or likely base vocabulary based upon assumptions or statistics known regarding the indicated features. As the user uses the system the known vocabulary may be built and the system may become more refined to the particular user. The known vocabulary is not necessarily a database of known and unknown words. For example, the known vocabulary may include a set of rules that the terms are compared against to determine whether the term is unfamiliar to the user.

In one embodiment, the knowledge of the base vocabulary may be identified through an optional initialization or training of the system. In one embodiment, the initialization may include a system start-up initialization including a testing mode. For example, the testing mode may include a test like presentation with a listing of vocabulary words, or a short story with different levels of vocabulary and the user indicates which words are familiar or unfamiliar. In one embodiment, the initialization may include an initialization mode which may include using the system for a period of time during which an embodiment monitors the user's written or spoken text. As the system is used, an embodiment may continually update the vocabulary base of the user. For example, if an embodiment presents a word and the user indicates that they are familiar with the word, an embodiment may update the base vocabulary to reflect this knowledge.

In one embodiment the base vocabulary may be nothing. For example, the system may be set up to start with a known base vocabulary containing no known familiar words. As another example, a user may choose to not provide any features or perform the initialization in order to create a base vocabulary. As with other methods, as the user uses the system, the vocabulary store will be updated and more refined to the particular user. A base vocabulary may be made using a combination of methods or other methods for creating a base vocabulary which are possible and contemplated, for example, using secondary sources to create a known vocabulary.

Alternatively, if an embodiment does not identify a particular user, an embodiment may make the determination using a history for the user. For example, during the course of the user using the device, the device may determine a base vocabulary for the user. Additionally, if an embodiment obtains any attributes relating to the user (e.g., social media, gender, age, profession, etc.), an embodiment may use this information in determining whether the user may be unfamiliar with a term.

In one embodiment, the determination may not be made using a base vocabulary set for the user. For example, the determination at 303 may, in one embodiment, be based upon how often a user encounters a term. For example, if a user encounters the term on a daily basis, an embodiment may determine that the user is familiar with the term. However, if the user encounters the term on a yearly basis, an embodiment may determine that the user is unfamiliar with the term. The frequency may also be based upon when the user last encountered the term. For example, if the user last encountered a term a month ago, an embodiment may determine that the user is unfamiliar with the term. In other words, an embodiment may determine that a term is familiar to a user, but that term may at some point be considered unfamiliar to the user based upon the length of time between encounters. As stated before, the known or base vocabulary of the user contained within the system is continually learning the vocabulary of the user and updating the known vocabulary within the system.

The determination at 303 may, in one embodiment, be based upon an action of the user. In other words, in one embodiment, the determination may be based upon the user indicating that a term is unfamiliar. The indication may include an active indication, for example, the user selecting a term, for example, highlighting, touching, pointing to, and the like. The indication may, alternatively, include a more passive indication. For example, a user may be consuming content on a tablet or computer and may hesitate or stare at an unfamiliar or unknown term. An embodiment may detect this hesitation using, for example, gaze tracking, and determine that the user is unfamiliar with the term based on this hesitation. As another example, a user may repeat a term that was just consumed, which may be an indicator that they are unfamiliar with the term. The determination at 303 may be made using a combination of methods. For example, a user may have created a base vocabulary using the initialization, but may also indicate a term as unfamiliar. Other methods of determining if a term is unfamiliar are possible and contemplated.

If at 303, an embodiment determines that the user is not unfamiliar with the term, an embodiment may do nothing at 305. An embodiment may additionally wait until a term is identified as unfamiliar to the user. If, however, an embodiment determines that the user is unfamiliar with a term, an embodiment may provide assistance relating to the identification of the unfamiliar terms at 304. The assistance may, in one embodiment, include providing a definition of the term, a synonym of the term, context clues relating to the term (e.g., use in a different sentence, type of term, field of study relating to the term, etc.), a generic term (e.g., if the term is a name for a prescription the term provided may be the generic term), and other types of assistance which may help the user in understanding the term.

In one embodiment, the assistance may comprise presenting a prompt asking the user if assistance is needed. For example, if a user is reading an Internet page an assistant or prompt box may be displayed asking if the user needs assistance. Alternatively, a term may be highlighted, circled, font color changed, or be otherwise denoted, indicating that an embodiment has determined that the user may need assistance with this term. The user may then click, highlight, select, or otherwise indicate that assistance is needed. Other indicators are possible, for example, if a user is the part of a conversation their information handling device may vibrate or sound indicating to the user that assistance is available. This assistance may also be sent to a second information handling device. For example, if an embodiment is contained on a smart phone and the user has a smart watch operatively coupled to the smart phone, an embodiment may send the assistance, for example, the definition, to be displayed on the smart watch.

The various embodiments described herein thus represent a technical improvement to a user in learning new terms. Using the techniques herein information handling devices can be leveraged to monitor content being consumed by a user. Upon determining that a user may be unfamiliar with a term, an embodiment may provide assistance in identification of the term. The user does not have to stop consuming the content to look up the term nor does the user have to fumble with an information handling device in order to find the term. Rather, an embodiment automatically provides the assistance needed by the user.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
obtaining, using a processor, content from a source, wherein the content comprises a plurality of terms;
determining, using a processor, that at least one of the plurality of terms is unfamiliar to a user; and
providing, to the user, assistance relating to identification of the at least one of the plurality of terms determined to be unfamiliar.

2. The method of claim 1, wherein the determining comprises calculating a probability relating to the likelihood that the user is unfamiliar with the at least one of the plurality of terms.

3. The method of claim 1, wherein the determining comprises ascertaining a frequency relating to how often the user encounters the at least one of the plurality of terms.

4. The method of claim 1, further comprising identifying a user consuming the content.

5. The method of claim 4, further comprising performing an initialization, wherein the initialization comprises determining a base vocabulary of a particular user and wherein the user identified is the particular user.

6. The method of claim 5, wherein the determining comprises using the initialization to determine whether the user identified is unfamiliar with the at least one of the plurality of terms.

7. The method of claim 1, wherein the determining comprises receiving an indication from the user that the user is unfamiliar with the at least one of the plurality of terms.

8. The method of claim 1, wherein the providing assistance comprises providing a prompt asking the user if assistance is needed.

9. The method of claim 1, wherein the providing assistance comprises providing a definition of the at least of the plurality of terms.

10. An information handling device, comprising:
a processor;
a memory device that stores instructions executable by the processor to:
obtain content from a source, wherein the content comprises a plurality of terms;
determine that at least one of the plurality of terms is unfamiliar to a user; and
provide, to the user, assistance relating to identification of the at least one of the plurality of terms determined to be unfamiliar.

11. The information handling device of claim 10, wherein to determine comprises calculating a probability relating to the likelihood that the user is unfamiliar with the at least one of the plurality of terms.

12. The information handling device of claim 10, wherein to determine comprises ascertaining a frequency relating to how often the user encounters the at least one of the plurality of terms.

13. The information handling device of claim 10, wherein the instructions are further executable by the processor to identify the user consuming the content.

14. The information handling device of claim 13, wherein the instructions are further executable by the processor to perform an initialization, wherein the initialization comprises determining a base vocabulary of a particular user and wherein the user identified is the particular user.

15. The information handling device of claim 14, wherein to determine comprises using the initialization to determine whether the user identified is unfamiliar with the at least one of the plurality of terms.

16. The information handling device of claim 10, wherein to determine comprises receiving an indication from the user that the user is unfamiliar with the at least one of the plurality of terms.

17. The information handling device of claim 10, wherein to provide assistance comprises providing a prompt asking the user if assistance is needed.

18. The information handling device of claim 10, wherein to provide assistance comprises providing a definition of the at least of the plurality of terms.

19. The information handling device of claim 11, wherein to provide assistance comprises providing the assistance to a device operatively coupled to the information handling device.

20. A product, comprising:
a storage device that stores code executable by a processor, the code comprising:
code that obtains content from a source, wherein the content comprises a plurality of terms;
code that determines that at least one of the plurality of terms is unfamiliar to a user; and
code that provides, to the user, assistance relating to identification of the at least one of the plurality of terms determined to be unfamiliar.
